(19) United States
(12) Patent Application Publication
(10) Pub. No.: US 2012/0001410 A1
(43) Pub. Date: Jan. 5, 2012

(54) BOOKMARK WITH HIGHLIGHTER

(76) Inventor: Tony Kok Ng, San Francisco, CA (US)

(21) Appl. No.: 13/020,435

(22) Filed: Feb. 3, 2011

Related U.S. Application Data
(60) Provisional application No. 61/360,396, filed on Jun. 30, 2010.

(51) Int. Cl. B42D 9/00; B43K 29/00

(52) U.S. Cl. 281/42; 401/131; 401/195

(57) ABSTRACT

A combination bookmark and highlighter device composed of a flat and thin bookmark body that may be marked with text or images. This bookmark body will have a head end and a back end. The head end of the bookmark body will have highlighter attached, often positioned within a slot in the head end of the bookmark body. The highlighter portion will usually contain a protruding highlighter tip positioned so that a user may grasp the device and use the tip to mark other objects. The bookmark portion of the body will be both thin and relatively stiff. Most of the portion of the bookmark body will not be occupied by the highlighter, so that the majority of the thin flat portion of the bookmark portion may be used as bookmark, leaving only a small portion of the bookmark body and highlighter body protruding from the book.

### CROSS REFERENCE TO RELATED APPLICATIONS

This application claims the priority benefit of U.S. provisional application 61/360,396, “BOOKMARK WITH HIGHLIGHTER”, filed Jun. 30, 2010, inventor Tony Kok Ng.

### BACKGROUND OF THE INVENTION

1. Field of the Invention

This invention is in the general field of bookmarkers and reading highlighters.

2. Description of the Related Art

Readers of books, magazines, and other printed material often have a desire to stop reading and insert a bookmarker at the relevant page so that they can quickly resume reading at a later time. These readers also often have a desire to use a marker, such as a highlighter, to select portions of the reading material deemed particularly important and mark selected text and graphics with a see-through color, often yellow, so as to facilitate remembering and rereading that selected material at a different time.

Generally bookmarkers are thin flat devices, often with a generally rectangular shape, and often made of paper, cardboard, plastic, metal or other thin material. Such flat designs are preferred because a non-flat design would tend to wrinkle the pages of the book or periodical, resulting in a potentially unacceptable degree of damage.

By contrast, highlighters are often designed as tubular structures, and often contain an inner chamber or reservoir with ink or other colored material, with usually a tip or nub of a bibulous material protruding from the inner chamber to the outside. This bibulous tip will usually calumniate in a tip which, for highlighting purposes, will often be a flat rather than a pointed end, to better facilitate evenly highlighting a single row of text at a time.

Previous workers have proposed combination bookmark and highlighter devices. For example, Diep, in U.S. Pat. No. 5,984,558, proposed a combination bookmark and highlighter comprised of a flat bookmarker portion, a pivot, and a tubular highlighter at the end of the pivot.

By contrast, Burket, in U.S. Pat. No. 6,006,693, proposed a bookmark device with a narrow low profile book mark portion, and an enlarged wider cap portion at the upper end. The cap portion of Burket's device served as the cap for a detachable highlighter pen. In this design, the bookmark portion itself did not contain any ink reservoir. Rather the ink reservoir was contained in a detachable highlighter head.

Armstrong, in U.S. Pat. No. 7,367,280 proposed a bookmark device not unlike a very thin flat conventional highlighter, in which, instead of the highlighter body and ink reservoir being tubular shaped, the highlighter body and ink reservoir was made roughly rectangular and relatively flat. This flattened highlighter design had a detachable cap at one end.

### BRIEF SUMMARY OF THE INVENTION

Despite such prior art, combination bookmarks and highlighters are still not in common use. The present invention is based, in part, upon the insight that further advancement in combination bookmark and highlighter design is both possible and desirable.

In one embodiment, the invention may be a combination bookmark and highlighter device composed of a substantially flat and thin bookmark body that may be printed or engraved or otherwise marked with text or images. This bookmark body will have a head end and a back end. The head end of the bookmark body will have highlighter attached, often positioned within a slot in the head end of the bookmark body. The highlighter portion will usually contain a protruding highlighter tip positioned so that a user may grasp the device, and use the tip to mark other objects. The bookmark portion of the body will be both thin and relatively stiff. Most of the area of the bookmark body will not be occupied by the highlighter, so that the majority of the thin flat portion of the bookmark portion may be used as bookmark, leaving only a small portion of the bookmark body and highlighter protruding from a book in use.

### BRIEF DESCRIPTION OF THE DRAWINGS

FIG. 1 shows a perspective view of one embodiment of the bookmark highlighter inserted between the pages of a book.

FIG. 2 shows a front and side view of an alternative embodiment of the bookmark highlighter.

FIG. 3 shows a detail of how the highlighter may fit into a slot in the head end of the highlighter, and how a cap may in turn fit onto the highlighter.

FIG. 4 shows an alternative embodiment in which the highlighter has an optional clip.

FIG. 5 shows a detail of the highlighter body, showing oppositely spaced groves designed to accommodate the edges of the bookmark body slot.

FIG. 6 shows a front view of the combination bookmark highlighter device being used to hold a place in a book or magazine, showing that most of the surface area of the device will generally be pressed between the pages of the book or magazine.

### DETAILED DESCRIPTION OF THE INVENTION

The invention is based, in part, upon considering problems associated with past combination bookmark highlighter designs. The pivot designs of Diep would appear to be both expensive and somewhat inconvenient, because the heavy marker at one end may cause the bookmark to fall out of proper position. The design of Burket also appears to have certain drawbacks, because the relatively heavy highlighter cap could easily become detached from the rest of the bookmark. The design of Armstrong has the problem that in order to accommodate an ink reservoir, the bookmark must be of appreciable thickness, thus increasing the possibility that the bookmark might inadvertently wrinkle the pages of books and magazines.

The invention's combination bookmark and highlighter device is designed to overcome the limitations of prior art. In at least one embodiment of the invention, the device may comprise a substantially flat and thin bookmark body with a length dimension and a width dimension. The bookmark body will normally have a head end positioned at one extreme of this length dimension and a back end positioned at the other extreme of this length dimension. The head end of the bookmark will generally have at least one slot to accommodate a highlighter, or multiple slots if multiple highlighters or a combination of highlighters and pens are desired. In each slot, a highlighter will be positioned or disposed, normally filling the slot, but then protruding at least partially past the head end of the bookmark. This highlighter (or highlighters) will usually have a protruding highlighter tip or nib so that a user may grasp the bookmark body and use the highlighter tip to mark other objects. Usually these other objects will be text or images disposed on the pages of the book or magazine that the user is reading.

It will be appreciated that when a thick object is positioned between the pages of a book or magazine, and the book or magazine then firmly shut, if the object is too thick—usually more than a few tenths of an inch, there can be an appreciable risk that the object will cause the pages of the book or magazine to become wrinkled or distorted, sometimes permanently, thus decreasing the value of the book or magazine and causing distress to the reader. Thus in a preferred embodiment, the body of the highlighter is made of relatively thin material, with a thickness less than about ¼ inch, and sometimes appreciably less than this, so as to avoid this unwanted page distortion.

It should also be appreciated, however that if the body of the bookmarker is too thin, then the bookmarker will become so flexible and “droopy” as to be difficult to use. Since the bookmarker body can be made of a relatively wide variety of materials, including relatively stiff paper cardstock (often 100 weight or higher), cardboard, various laminates, plastic, metal and the like, the lower bound of what constitutes a “too thin” bookmark will somewhat vary with the material that is used for the bookmark body. As a rough guide, in a preferred embodiment, the combination of bookmark body thickness, bookmark body dimensions, and weight of the highlighter should be such that when the bookmarker highlighter device is held from its back end in a horizontal manner, thus allowing gravity to act upon the heavier highlighter portion of the device, then the overall droop of the bookmarker highlighter device should not be more than about 20 degrees off from the horizontal. In other words, the body should be stiff enough to be able to substantially support the weight of the head end and highlighter when held from the back end.

In general, the combination bookmarker and highlighter device will have dimensions such that the device may be positioned between the pages of a book or magazine so that said back end and at least 75 percent of the area of said bookmarker body may be positioned within the pages, and the remaining area of the bookmarker body including the head end, slot, and highlighter may protrude beyond the edges of the pages when the book or magazine is in a closed position.

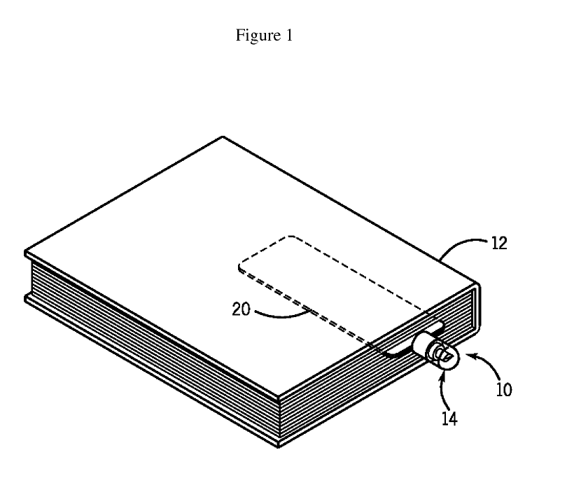

FIG. 1 shows a drawing of one embodiment of the combination bookmark and highlighter (10), used between the pages of a book (12). Here almost all of the body of the bookmark (20), which in this embodiment has a generally rectangular shape, fits within the pages of the book (12). The nib or tip of the highlighter is shown as (14). Often the body of the bookmark will have a length of between 2 and 8 inches, and a width of between ½ inches to 5 inches. The bookmark body thickness will often range between a low of about 0.004 inches and a high of about 0.25 inches, and will often consist of a thin and relatively stiff material. This material may itself be printable, etchable, or otherwise markable, or alternatively can be treated so that it can bear marks such as text and graphic marks.

The body of the highlighter may be of many different shapes. In some embodiments, the shapes will have at least a longest length (length) that will be often 2 times, 3 times, 4 times or more longer than the width of the shortest dimension of the highlighter. Common highlighter shapes may include substantially rectangular shapes (here the term “substantially rectangular” is used because the corners of the rectangle may often be rounded, beveled, or otherwise deviate from a pure 90 degree angle).

In other embodiments, the body of the bookmarker may have a triangular shape, a circular shape, or a more complex shape such as a combination of a substantially rectangular base and a substantially trapezoidal head. The body of the bookmarker can also have an irregular shape such as the shape of recognizable figures such as animals, plants, humans, human made objects (e.g. an automobile shaped bookmark), geographic figures (e.g. continents, mountains), astronomical shapes and the like. The body of the bookmarker may also have one or more holes.

Often the flat surface of the bookmarker will be printed, embossed, overlaid with paper, or somehow marked to show various types of materials, such as advertisements, useful reference markers such as rulers, conversion tables, phone numbers, instructions, inspirational sayings and the like, and suitable graphic images as desired.

The bookmark highlighters of the invention can be made of plastic, for example ABS plastic (acrylonitrile, butadiene, and styrene) by a variety of different processes including extrusion and cutting, injection molding, stamping, dye cutting, printing, and the like.

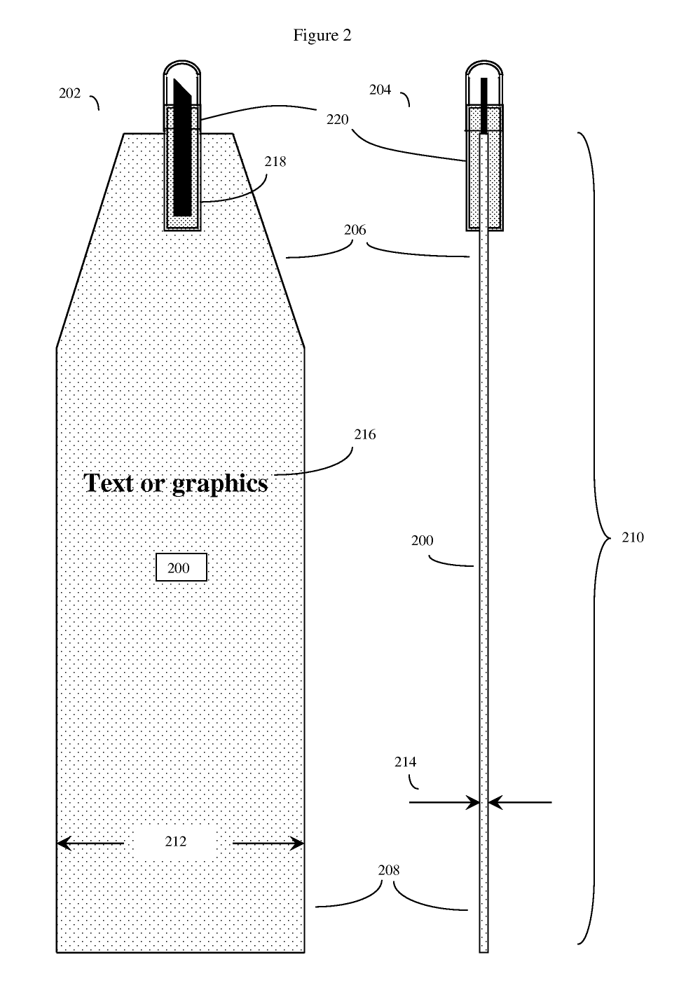

FIG. 2 shows a front (202) and side view (204) of an alternative embodiment of the bookmark highlighter device. Here the body of the bookmark (200) has a head end (206), and a back end (208). The bookmark body also has a maximum length dimension (210), a maximum width dimension (212), and a thickness dimension (214). Generally one or both of the main flat sides of the bookmarker body may be marked, printed or embossed or will otherwise display text and graphics as desired (216).

The head end of the bookmark will generally have at least one slot (218) with a highlighter (220) affixed within this slot.

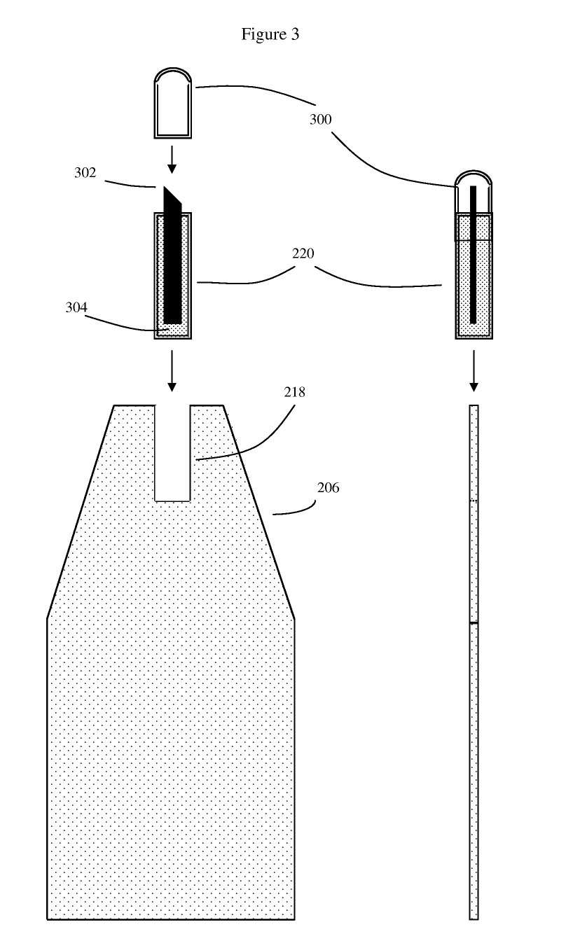

FIG. 3 shows a detail of how the highlighter (220) may fit into a slot (218) in the head end of the bookmark body (206), and how a cap (300) may in turn fit onto the highlighter (220). The tip or nib of the highlighter can be seen as (302), and the interior of the highlighter, which will often contain ink, is shown as (304).

The highlighter (220) can be permanently affixed to the body (200) and slot (218) of the bookmark (200), either thermal melting, molding, or otherwise creation of the highlighter and bookmark body so as to create a continuous unit. Alternatively the highlighter may be glued to the bookmark, adhered with tape or other adhesive material.

In an alternative embodiment, however, highlighter (220), slot (218) and bookmark body (200) may be designed so that the highlighter may be replaced by either the manufacturer or end user. This may be conveniently be done though use of slots or groves on opposite sides of the highlighter body, so that there is a relatively firm pressure fit between the groves on the highlighter body and the edges of the slots (218), thus causing the highlighter to be firmly yet removeably attached to the bookmark body (200).

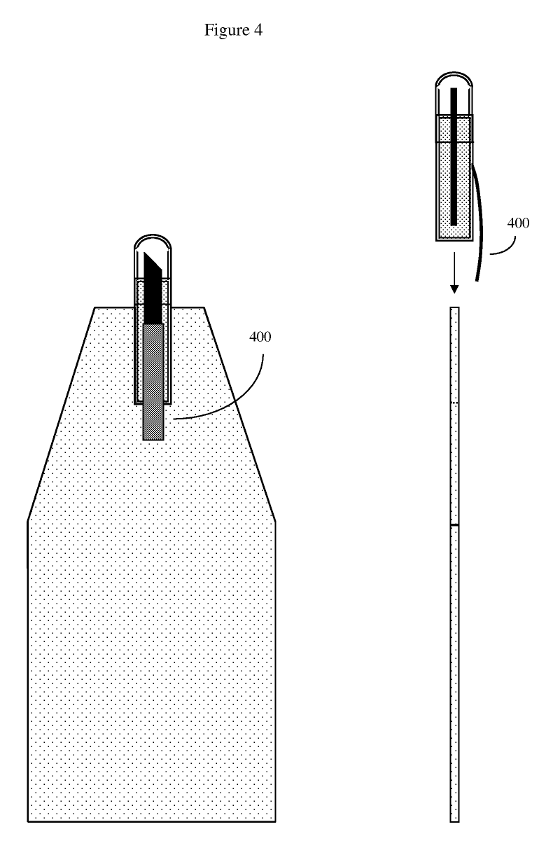

FIG. 4 shows an alternative embodiment in which the highlighter has an optional clip (400). This clip will often be designed to have some spring action or be otherwise somewhat reversibly deformable as to allow the bookmarker to be clipped to another page or cover of the book or magazine when not being used as a bookmarker, and then rapidly removed and put into position as a bookmarker when this function is desired.

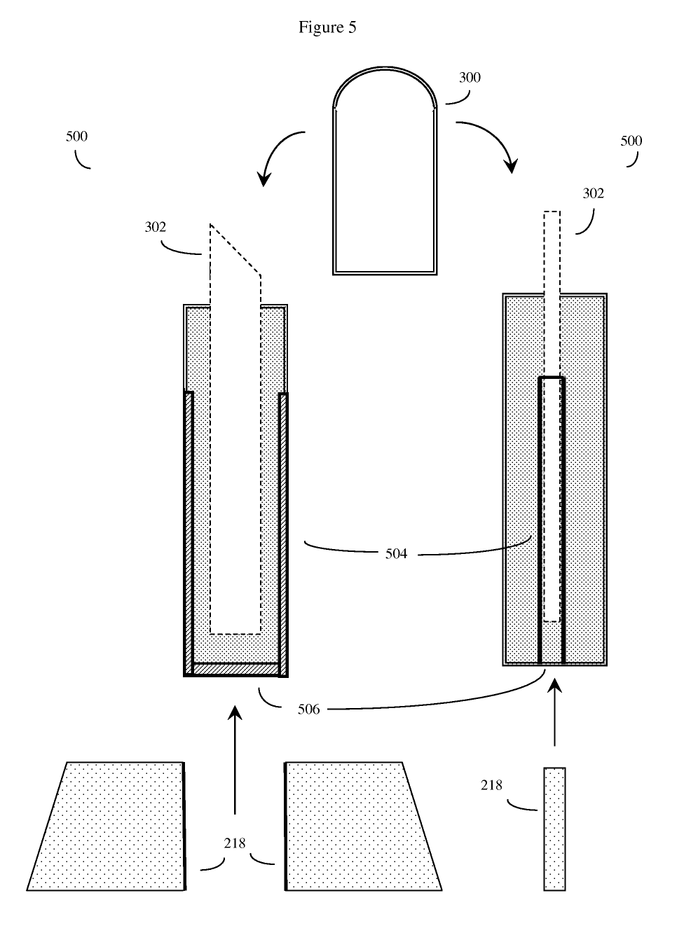

FIG. 5 shows a detail of the highlighter body from the front (500) and side (502) position, showing oppositely spaced groves or highlighter slots or highlighter guides (504) designed to accommodate the edges of the bookmarker slot (218). Ideally the groves or highlighter slots or guides may be configured so as to create at least a mild pressure fit with the edges of the bookmarker slot, thus securing the highlighter into place, yet allowing the user to replace the highlighter when replacement is so desired. Often the bottom of the highlighter may also have a groove or slot or guide (506) as well so as to fit over the lower lip of the bookmarker slot (218).

In alternative embodiments, other fastening arrangements, such as snap on pins, or other reversible mechanical attachment, may be used.

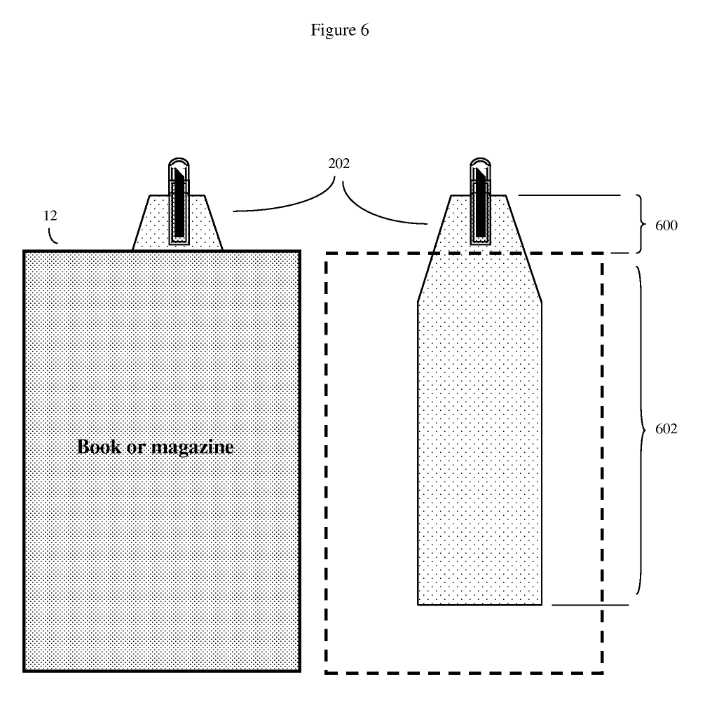

FIG. 6 shows a front view of the combination bookmark highlighter device being used to hold a particular page in a book or magazine, showing that most of the surface area of the device will generally be pressed between the pages of the book or magazine. Normally the fraction of the surface area of the bookmark that contains the highlighter and that that is not between the pages (600) will be substantially smaller than the fraction of the surface area of the bookmark that is between the pages of the book or magazine (602). Typically only at most about 25% of the surface area of the bookmark will be rendered unsuitable for placing between the pages by the thicker highlighter, leaving at least 75% of the surface area of the bookmark in a thin and flat configuration suitable for placed between the pages of the book or magazine without distorting the pages. In other configurations, 20%, 15%, 10% or less of the bookmark surface area may be rendered unsuitable for use as a bookmark (at least with respect for positioning between the pages) by the thicker highlighter.

It should be understood, of course, that the foregoing relates to exemplary embodiments of the invention and that modifications may be made without departing from the spirit and scope of the invention as set forth in the following claims.

1. A combination bookmark and highlighter device, comprising:
a substantially flat and thin bookmark body with a length dimension and a width dimension;
said body having a head end positioned at one extreme of said length dimension and a back end positioned at the other extreme of said length dimension;
said head end having at least one slot;
at least one highlighter at least partially positioned within said at least one slot;
said at least one highlighter having a protruding highlighter tip so that a user may grasp the device and use said at least one highlighter tip to mark other objects;
wherein said device may be positioned between the pages of a book or magazine so that said back end and at least 75 percent of the area of said body may be positioned within said pages, and said body will not substantially distort said pages when said book or magazine is in a closed position; and
wherein the remaining area of said body including the head end, slot, and highlighter may protrude beyond the edges of said pages when said book or magazine is in a closed position.

2. The device of claim 1, wherein said highlighter is bonded to said body.

3. The device of claim 1, wherein said highlighter is replaceable.

4. The device of claim 1, wherein said highlighter has oppositely disposed groves or guides configured so that said highlighter may be slid between the edges of said slots and remain firmly attached to said body.

5. The device of claim 1, wherein said highlighter further comprises a removable cap.

6. The device of claim 1, wherein said highlighter further comprises a clip mounted on a side of said highlighter.

7. The device of claim 1, wherein said body is marked with text or images.

8. The device of claim 1, wherein the shape of at least the portion of said body containing said back end is substantially rectangular.

9. The device of claim 1, wherein the stiffness of said body is at least stiff enough so that when said body is held by said back end, said head end and said highlighter will not substantially droop.

10. The device of claim 1, wherein said body is made from paper card stock, cardboard, plastic, metal, or other material.

11. A combination bookmark and highlighter device, comprising:
a substantially flat and thin bookmark body with a length dimension and a width dimension;
said body having a head end positioned at one extreme of said length dimension and a back end positioned at the other extreme of said length dimension;
wherein said body is marked with text or images;
said head end having a slot;
a highlighter at least partially positioned within said slot;
said highlighter having a protruding highlighter tip so that a user may grasp the device and use said tip to mark other objects;
wherein said device may be positioned between the pages of a book or magazine so that said back end and at least 75 percent of the area of said body may be positioned within said pages, and said body will not substantially distort said pages when said book or magazine is in a closed position;
wherein the stiffness of said body is at least stiff enough so that when said body is held by said back end, said head end and said highlighter will not substantially droop; and
wherein the remaining area of said body including the head end, slot, and highlighter may protrude beyond the edges of said pages when said book or magazine is in a closed position.

12. The device of claim 11, wherein said highlighter is bonded to said body, or wherein said highlighter is replaceable.

13. The device of claim 1, wherein said highlighter has oppositely disposed groves or guides configured so that said highlighter may be slid between the edges of said slots and remain firmly attached to said body.

14. The device of claim 1, wherein said highlighter further comprises a removable cap and/or wherein said highlighter further comprises a clip mounted on a side of said highlighter.

15. The device of claim 1, wherein said body is made from paper card stock, cardboard, plastic, metal or other material.

16. A combination bookmark and highlighter device, comprising:
a substantially flat and thin bookmark body with a length dimension and a width dimension;
said body having a head end positioned at one extreme of said length dimension and a back end positioned at the other extreme of said length dimension;
wherein said body is marked with text or images;
said head end having a slot;
a replaceable highlighter at least partially positioned within said slot;
said highlighter having a protruding highlighter tip so that a user may grasp the device and use said highlighter tip to mark other objects;
wherein said highlighter has oppositely disposed groves or guides configured so that said highlighter may be slid between the edges of said slots and remain firmly attached to said body;
wherein said device may be positioned between the pages of a book or magazine so that said back end and at least 75 percent of the area of said body may be positioned within said pages, and said body will not substantially distort said pages when said book or magazine is in a closed position;
wherein the stiffness of said body is at least stiff enough so that when said body is held by said back end, said head end and said highlighter will not substantially droop; and
wherein the remaining area of said body including the head end, slot, and highlighter may protrude beyond the edges of said pages when said book or magazine is in a closed position.

17. The device of claim 16, wherein said highlighter further comprises a removable cap and/or wherein said highlighter further comprises a clip mounted on a side of said highlighter.

18. The device of claim 16, wherein said body is made from paper card stock, cardboard, plastic, or metal or other material.

19. The device of claim 16, wherein the shape of at least the portion of said body containing said back end is substantially rectangular.

20. The device of claim 16, wherein the shape of at least the portion of said body containing said head end is substantially trapezoidal.
